(19) United States
(12) Patent Application Publication
(10) Pub. No.: US 2003/0142231 A1
(43) Pub. Date: Jul. 31, 2003

(54) Digital camera

(75) Inventors: Koji Yasuda, Osaka (JP); Shoichi Minato, Osaka (JP)

Correspondence Address: MCDERMOTT, WILL & EMERY, 600 13th Street, N.W., WASHINGTON, DC, 20005-3096, US

(73) Assignee: Minolta Co., Ltd.

(21) Appl. No.: 10/345,375

(22) Filed: Jan. 16, 2003

(30) Foreign Application Priority Data
Jan. 28, 2002 (JP) 2002-18201

(51) Int. Cl. H04N 5/225

(52) U.S. Cl. 348/373; 348/335

(57) ABSTRACT

A digital camera capable of optimizing the circuit board disposition in a relationship with other parts when an optical system having refracting means for refracting the subject light is adopted, comprising: a body having a shape being flat in a subject direction when photographing; a refracting optical system having refracting means for refracting incident light from a subject in a direction vertical to the subject direction of the body; a power source portion supplying power to the image forming apparatus; and a circuit board disposed so as not to overlap with the refracting optical system and the power source portion in a direction of a thickness in the subject direction of the body.

This application is base on Japanese Patent Application No. Hei 2002-18201 filed in Japan on Jan. 28, 2002, the entire content of which is hereby incorporated by reference.

### FIELD OF THE INVENTION

The present invention relates to a digital camera, and more particularly, to the disposition of components used in a digital camera including a lens barrel unit having refracting means for refracting the subject light and imaging the light on an image sensing device.

### DESCRIPTION OF THE RELATED ART

In digital cameras electronically recording image signals converted by the image sensing device, since no film is used unlike film-based cameras, no film driving system is required, and since there is little limitation on the position of the image sensing device for this reason, the taking optical axis can be refracted on the way. Therefore, it is proposed to form an optical system having refracting means such as a mirror or a prism in the middle of the taking optical system to thereby reduce the thickness of the digital camera.

For example, in an electronic camera disclosed in Japanese Laid-Open Patent Application No. 2000-10165, an optical system is disposed in an upright position in a notch of an in-body electric circuit board disposed in the center of a flat body so as to be parallel to the front wall of the body, and a battery cavity is disposed in the vertical direction at a side of the optical system. Behind the lens barrel unit, an image display is disposed.

However, in the camera disclosed in the laid-open patent application, while a notch is formed in a member in order that the optical system does not interfere with other members, the thickness of the camera is not sufficiently reduced in disposing the optical system in combination with other parts provided inside.

### SUMMARY OF THE INVENTION

The present invention is made to solve the above-mentioned problem, and an object thereof is to provide a very thin digital camera by optimizing the circuit board disposition in a relationship with other parts when an optical system having refracting means for refracting the subject light is adopted. Another object of the present invention is to inexpensively provide a very thin digital camera as described above.

The above-mentioned objects are attained by providing digital cameras having the following structures:

An image forming apparatus of the present invention comprises: a body having a shape being flat in a subject direction when photographing; a refracting optical system having refracting means for refracting incident light from a subject in a direction vertical to the subject direction of the body; a power source portion supplying power to the image forming apparatus; and a circuit board disposed so as not to overlap with the refracting optical system and the power source portion in a direction of a thickness in the subject direction of the body.

As described above, according to the present embodiment, the circuit board can be disposed in a space other than the space occupied by the lens barrel unit and the battery cavity which are large parts in the body, so that the thickness of the camera can be reduced.

In the above-described structure, the refracting optical system is disposed at an end of the body.

In the above-described structure, the power source portion is disposed at an end of the body.

In the above-described structure, a display portion is provided that is disposed so as to overlap with the circuit board in the direction of the thickness in the subject direction of the body.

In the above-described structure, a flash capacitor is provided that is disposed so as to overlap with the circuit board in the direction of the thickness in the subject direction of the body.

In the above-described structure, a recording medium housing portion is provided that is disposed so as to overlap with the circuit board in the direction of the thickness in the subject direction of the body.

Moreover, an image forming apparatus of the present invention comprises: a body having a shape being flat in a subject direction when photographing; a refracting optical system disposed at an end of the body, and having refracting means for refracting incident light from a subject in a direction vertical to the subject direction of the body; and a power source portion supplying power to the image forming apparatus, and disposed at an end adjoining the end where the refracting optical system is disposed.

As described above, according to the present embodiment, the lens barrel unit and the battery cavity are disposed in an L shape along the left end and the lower end of the body, so that a large space surrounded thereby can be secured. Consequently, a comparatively large member can be disposed in this space, and since the space is rectangular, facilitation of circuit board formation and reduction in cost can be attained.

In the above-described structure, a circuit board is provided that is disposed so as not to overlap with the refracting optical system and the power source portion in the direction of a thickness in the subject direction of the body.

In the above-described structure, a display portion is provided that is disposed so as to overlap with the circuit board in the direction of the thickness in the subject direction of the body.

In the above-described structure, a flash capacitor is provided that is disposed so as to overlap with the circuit board in the direction of the thickness in the subject direction of the body.

In the above-described structure, a recording medium housing portion is provided that is disposed so as to overlap with the circuit board in the direction of the thickness in the subject direction of the body.

Further, an image forming apparatus of the present invention comprises: a body having a shape being flat in a subject direction when photographing; a refracting optical system having refracting means for refracting incident light from a subject in a direction vertical to the subject direction of the body; and a display portion displaying a taken image, and disposed so as not to overlap with the refracting optical system in the direction of a thickness in the subject direction of the body and to overlap with the refracting optical system in a direction vertical to the subject direction.

As described above, according to the present embodiment, a LCD is disposed within the thickness of the lens barrel unit in the body, so that the thickness of the camera can be reduced.

In the above-described structure, the refracting optical system is disposed at an end of the body.

In the above-described structure, a power source portion is provided that supplies power to the image forming apparatus and is disposed so as not to overlap with the refracting optical system and the display portion in the direction of the thickness in the subject direction of the body.

In the above-described structure, a circuit board is provided that is disposed so as to overlap with the display portion in the direction of the thickness in the subject direction of the body.

In the above-described structure, a second circuit board is disposed in the direction of the thickness in the subject direction of the body.

In the above-described structure, a third circuit board is provided that is disposed in a direction substantially orthogonal to the circuit boards.

In the above-described structure, a recording medium housing portion is provided that is disposed so as to overlap with the display portion in the direction of the thickness in the subject direction of the body.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a front cross-sectional view of a digital camera according to a first embodiment of the present invention;

FIG. 2 is a rear cross-sectional view of the digital camera of FIG. 1;

FIG. 3 is a top cross-sectional view of the digital camera of FIG. 1;

FIG. 4 is a right side cross-sectional view of the digital camera of FIG. 1;

FIG. 5 is a left side cross-sectional view of the digital camera of FIG. 1;

FIG. 6 is a front cross-sectional view of a digital camera according to a second embodiment of the present invention;

FIG. 7 is a top cross-sectional view of the digital camera of FIG. 6;

FIG. 8 is a left side cross-sectional view of the digital camera of FIG. 6;

FIG. 9 is a front cross-sectional view of a digital camera according to a third embodiment of the present invention;

FIG. 10 is a top cross-sectional view of the digital camera of FIG. 9;

FIG. 11 is a right side cross-sectional view of the digital camera of FIG. 9; and

FIG. 12 is a left side cross-sectional view of the digital camera of FIG. 9.

### DETAILED DESCRIPTION OF THE PREFERRED EMBODIMENTS

Hereinafter, digital cameras according to embodiments of the present invention will be described with reference to the drawings.

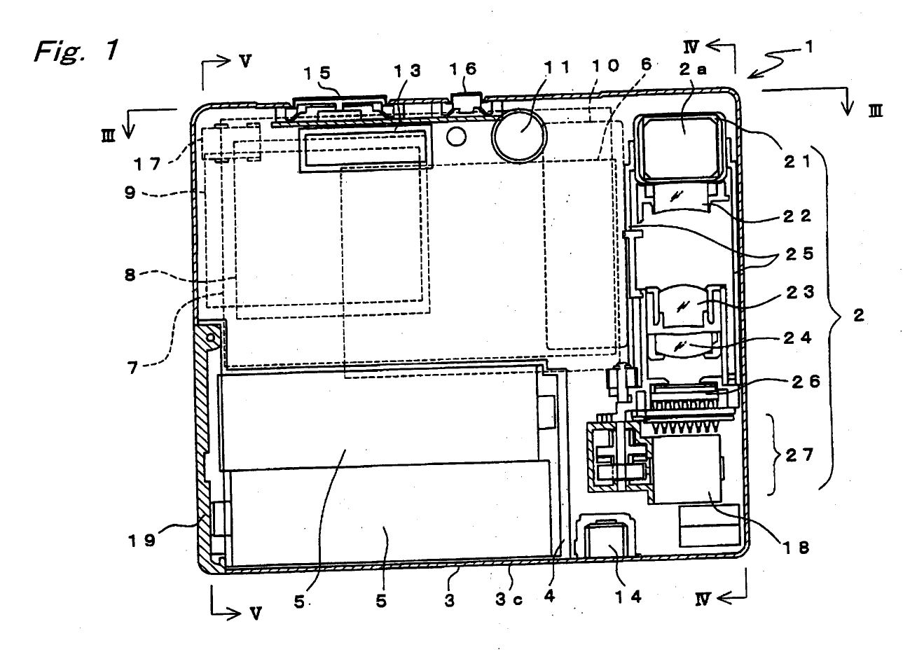

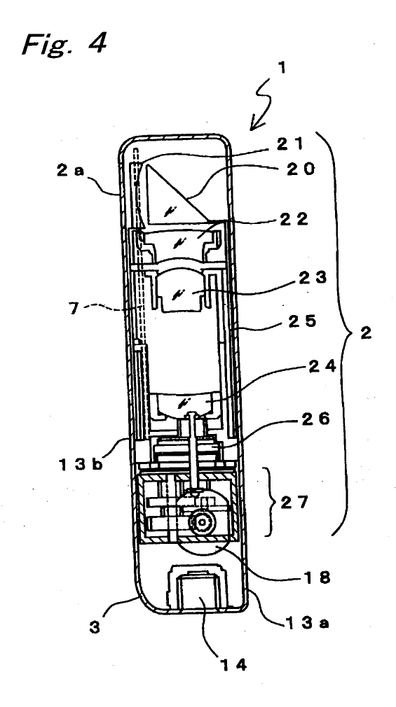

First, a digital camera according to a first embodiment of the present invention will be described with reference to FIGS. 1 to 5.

As shown in the front cross-sectional view of FIG. 1, the digital camera 1 according to the first embodiment of the present invention has a lens barrel unit 2 in the body 3 at the right end viewed from the front wall of the body. The lens barrel unit 2 comprises taking lens units 21, 22, 23 and 24 taking in the subject light, a lens barrel 25, an image sensing device 26 outputting a subject image sensing signal and a zoom driver 27 driving the zoom lens unit 22 for adjusting the focal length of the lens barrel unit. At a side of the lens barrel unit 2, a battery cavity 4 for housing batteries 5 is disposed along the bottom wall 3c of a body 3 so that the direction of the length thereof coincides with the lateral direction. In a large space formed by disposing the lens barrel unit 2 and the battery cavity 4 on one side in an L shape, a liquid crystal display 6 and a circuit board 7 are disposed so as not to overlap with the lens barrel unit 2 in the direction of the thickness.

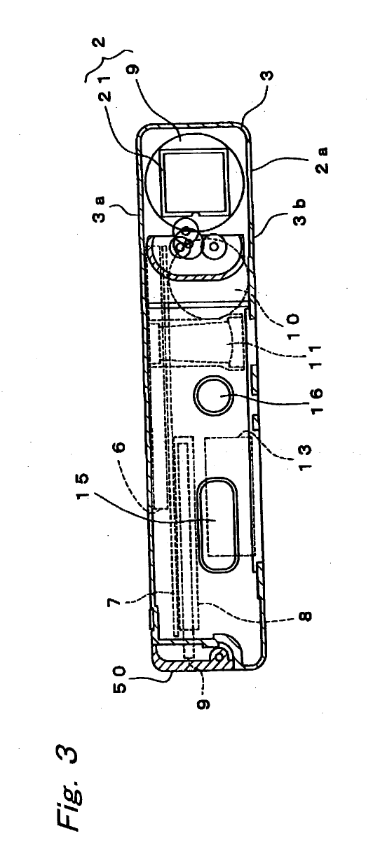

First, the external structure of the digital camera 1 will be described. As shown in FIGS. 1 to 5, the body 3 has a flat shape having a front wall 3b and a rear wall 3a and being smaller in thickness than in height and in width. As shown in FIG. 1 and FIG. 3 which is a top cross-sectional view, the body 3 has an opening 2a for the lens barrel unit 2 in an upper right part of the front wall 3b which is opposed to the subject at the time of photographing. At the left side of the opening 2a, a finder 11 and a flash 13 are provided.

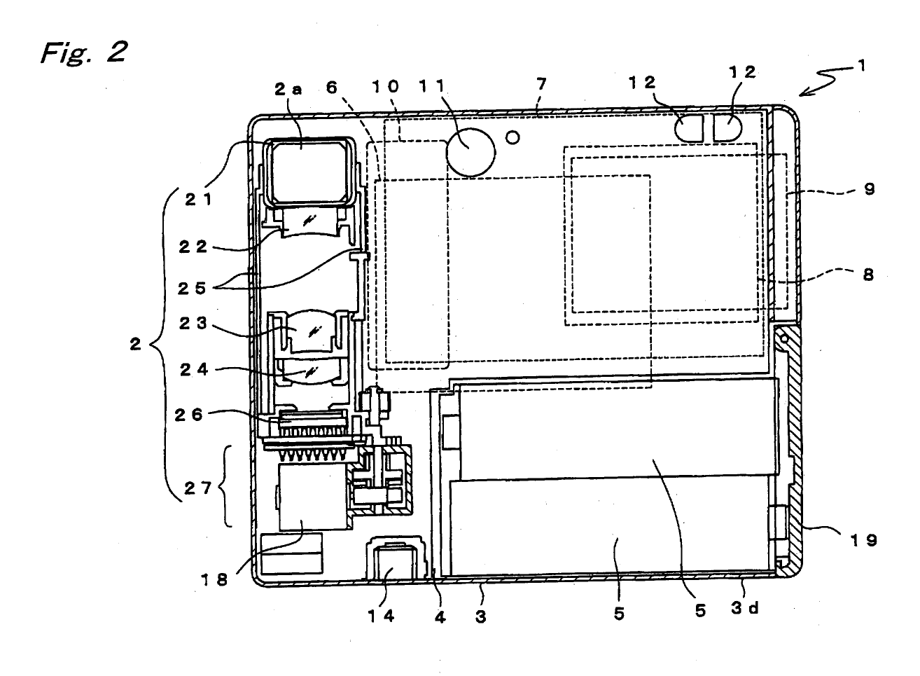

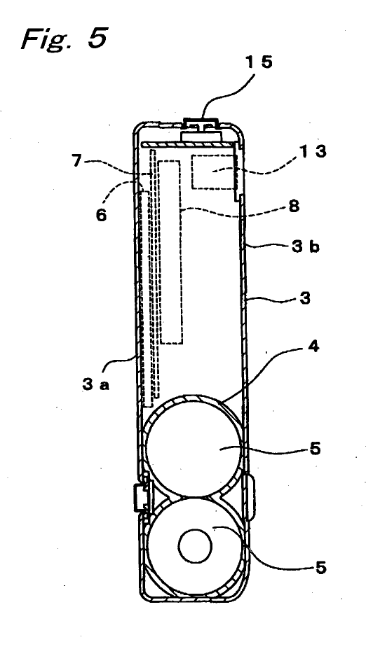

As shown in the rear cross-sectional view of FIG. 2, the top cross-sectional view of FIG. 3 and the left side cross-sectional view of FIG. 5, the liquid crystal display 6 for displaying images and zoom buttons 12a and 12b are provided on the rear wall 3a of the body 3. The zoom buttons 12a and 12b comprise a telephoto-side button 12a and a wide-angle button 12b. By depressing one of these buttons, the zoom driver 27 is driven to move the zoom lens unit 23.

As shown in FIG. 1 and FIG. 3 which is a top cross-sectional view, a release button 15 for photographing instruction operation and a main switch 16 are provided on the top wall of the body 3.

Next, the internal structure will be described. The subject light is incident on the lens barrel unit 2 through the opening 2a. As mentioned above, the lens barrel unit 2 is provided in the vertical direction at the right end of the body 3. Light incident vertically to the front wall 3b of the body passes through the first lens unit 21, and is refracted downward by a prism 20. In the lens barrel 25, the second to the fourth lens units are housed. The second lens unit 22 serving as a focusing lens unit performs focusing by varying its position in the direction of the optical axis. Below the second lens unit 22, the third lens unit 23 serving as the zoom lens unit moved by the zoom driver 27 is provided. The light refracted by the prism 20 is incident on the image sensing device 26 through the second to the fourth lens units 22 to 24.

Below the image sensing device 26, the zoom driver 27 for driving the third lens unit 23 serving as the zoom lens unit is provided. Below the zoom driver 27, a tripod screw 14 is provided on the bottom surface of the body 3. This disposition enables effective use of a small dead space formed below the lens barrel unit 2.

At the left side of the lens barrel unit 2, the battery cavity 4 is provided. The battery cavity 4 is disposed on the bottom wall of the body 3 so that the direction of the length thereof coincides with the horizontal direction and so as not to overlap with the lens barrel unit 2 in the direction of the thickness of the body. In the battery cavity 4, two batteries 5 are placed one on the other in the vertical direction so as not to overlap with each other in the direction of the thickness of the camera. The batteries 5 are horizontally taken in and out from the left side surface of the body, and a battery cover 19 is attached to the left side surface of the body so as to be openable and closable.

Above the battery cavity, the liquid crystal display 6 and the circuit board 7 are disposed. The liquid crystal display 6 may be disposed so as to overlap with the battery cavity 4 in the direction of the height. In the present embodiment, as shown in FIG. 5, when the battery cavity 4 is for housing cylindrical batteries, the peripheral wall of the battery cavity 4 curves along the arc of the batteries 5, and the liquid crystal display 6 is disposed so that its lower end is inserted in a substantially triangular space formed between the battery cavity 4 and the rear wall 3b of the body 3 so as to make a close contact with the upper end of the peripheral wall. This disposition enables the size of the liquid crystal display 6 to be increased.

In front of the liquid crystal display 6, a memory slot 8 for inserting a memory card 9 is provided so as to overlap with the liquid crystal display 6 in the direction of the thickness. The circuit board 7 is disposed so as to be sandwiched between the liquid crystal display 6 and the memory slot 8. On the circuit board, wiring for connecting units such as the liquid crystal display 6, the flash 13 and the zoom driver 27, and controllers and devices for controlling the parts are disposed. Since the members disposed so as to overlap with one another are each a thin member, even though they are disposed so as to overlap with one another in the direction of the thickness of the body, the overall thickness thereof can be made smaller than the thickness of the lens barrel unit 2.

Between the memory slot 8 and the lens barrel unit 2, a main capacitor 10 for the flash 13 is provided. The main capacitor 10 is disposed in front of the liquid crystal display 6 so as to overlap with the liquid crystal display 6 in the direction of the thickness. Moreover, a USB terminal 17 for transmitting and receiving data of taken images and the like is provided on the left side surface of the body so as to overlap with the memory slot 8 in the direction of the thickness. The memory slot 8 and the USB terminal 17 are normally covered with a cover 50, and taking in and out of the memory card and USB connection to another apparatus are possible with the cover opened.

As described above, according to the present embodiment, the lens barrel unit 2 and the battery cavity 4 are disposed in an L shape along the left end and the lower end of the internal cavity of the body, and a large space surrounded thereby can be secured. By disposing thin members such as the circuit board and the LCD in the large space, the memory card slot 8 which is also a thin member and other parts can be disposed so as to overlap with one another in the direction of the thickness. Even though disposed in this manner, these members can be housed without the overall thickness thereof exceeding the thickness of the lens barrel unit 2, so that the thickness of the camera can be reduced.

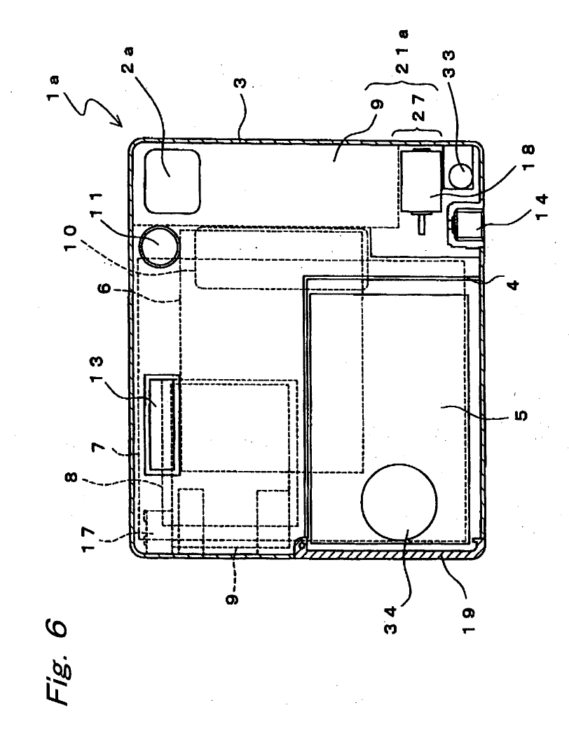

Next, a digital camera according to a second embodiment of the present invention will be described with reference to FIGS. 6 to 8.

A digital camera 1a has a lens barrel unit 2 in a body 3 at the right end viewed from the front wall 3b of the body. The lens barrel unit 2 is a bending optical system similar to the first embodiment, and comprises taking lens units taking in the subject light, a lens barrel, an image sensing device outputting a subject image sensing signal and a zoom driver 27 driving the zoom lens unit. In the present embodiment, as shown in the front cross-sectional view of FIG. 6, at the left side of the lens barrel unit 2, a liquid crystal display 6 is disposed so as not to overlap with the lens barrel unit 2 in the direction of the thickness and to be in contact with the rear wall 3a of the body 3. Moreover, a memory slot 8 for inserting a memory card 9 is provided so as to overlap with the liquid crystal display 6 in the direction of the thickness of the camera. Moreover, a circuit board 7 is provided so as to be sandwiched between the liquid crystal display 6 and the memory slot 8. Since these members are each small in thickness, even though they are disposed so as to overlap with one another in the direction of the thickness of the body, the overall thickness thereof can be made smaller than the thickness of the lens barrel unit 2. The circuit board 7 occupies, when viewed from the side of the front wall 3b, substantially all the space other than the space occupied by the lens barrel unit 2 and the zoom driver 27.

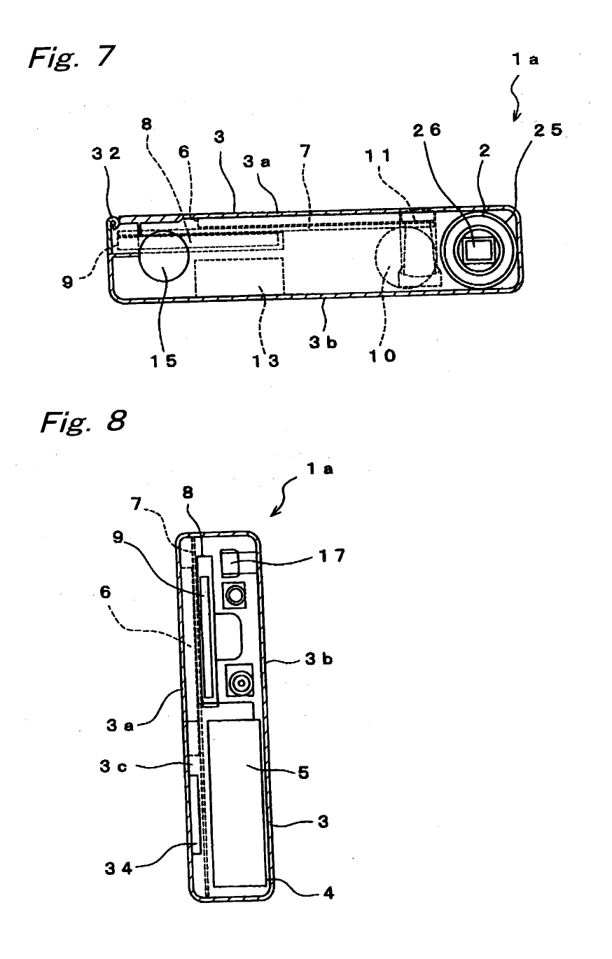

The memory card 9 is inserted into the memory slot 8 from the left side of the camera 1a. On the left side surface of the body, a USB terminal 17 for transmitting and receiving image data and sound data is provided. As shown in the top cross-sectional view of FIG. 7, on the left side surface of the camera 1a, a recording medium cover 32 for protecting the memory slot 8 and the USB terminal 17 is provided so as to be openable and closable.

As shown in FIG. 6, at the lowermost part of the lens barrel unit 2b, the zoom driver 27 including a motor 18 is situated, and below the zoom driver 27, a microphone 33 is disposed. At a side of the microphone 33, a tripod screw 14 is provided.

Moreover, as shown in FIG. 7, a release button 15 is provided on the top wall of the camera.

At the lower left of the lens barrel unit 2, a battery cavity 4 is disposed on the bottom wall of the body 13 so as not to overlap with the lens barrel unit 2 in the direction of the thickness and that the direction of the length thereof coincides with the lateral direction. In this embodiment, a rechargeable flat secondary battery is used as a battery 5a. Since the battery is flat as mentioned above, as shown in the left side cross-sectional view of FIG. 8, a space 3c is present between the battery cavity 4 and the rear wall 3a of the body. The battery 5a is inserted into the battery cavity from the left side surface of the camera, and to protect the slot, a battery cover 19 is provided on the left side surface of the body 3.

The liquid crystal display 6 is disposed so that at least part thereof is inserted in the space 3c formed between the battery cavity 4 and the rear wall 3a of the body. This disposition enables reduction in the size of the camera in the direction of the height. Moreover, in the space 3c, a speaker 34 is disposed below the liquid crystal display 6.

A flash 13 is provided above the liquid crystal display 6. The flash 13 is disposed so as to overlap with the memory slot 8 and the liquid crystal display 6 in the direction of the thickness.

As shown in FIGS. 6 and 7, at the left side of the lens barrel unit 2, a main capacitor 10 for the flash 13 is provided. The main capacitor 10 is disposed so as to overlap with the liquid crystal display 6 in the direction of the thickness. A finder 11 is disposed above the liquid crystal display 6 and the main capacitor 10. Since the finder 11 does not overlap with the liquid crystal display 6 and the main capacitor 10 in the direction of the width, the size of the camera in the direction of the width can be reduced.

According to the present embodiment, since the circuit board is disposed in the space other than the space occupied by the lens barrel unit, by determining the thickness of the body with the lens barrel unit as the reference, the thickness of the camera can be reduced. In that case, since substantially all the space other than the space occupied by the lens barrel unit is used, a maximum circuit board size for a single-circuit-board structure can be obtained.

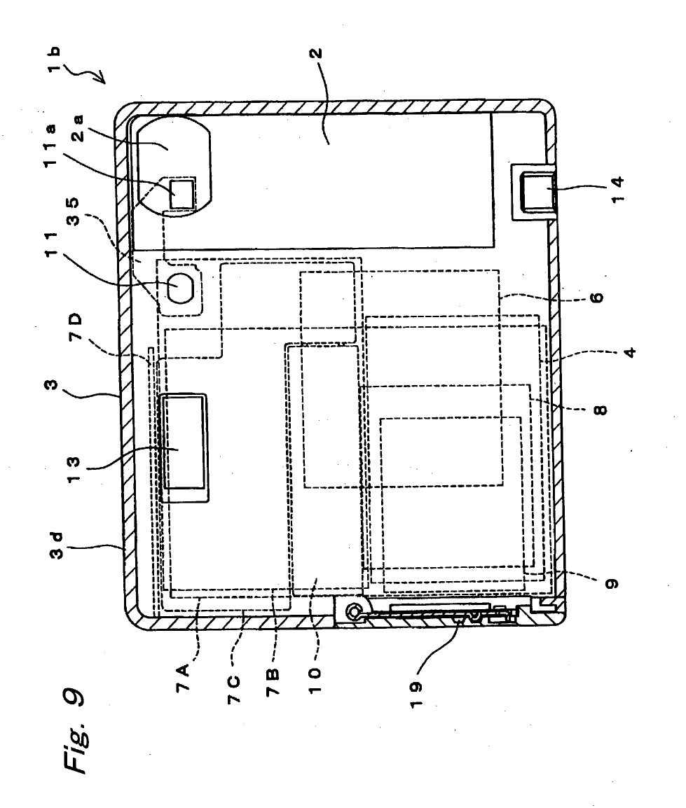

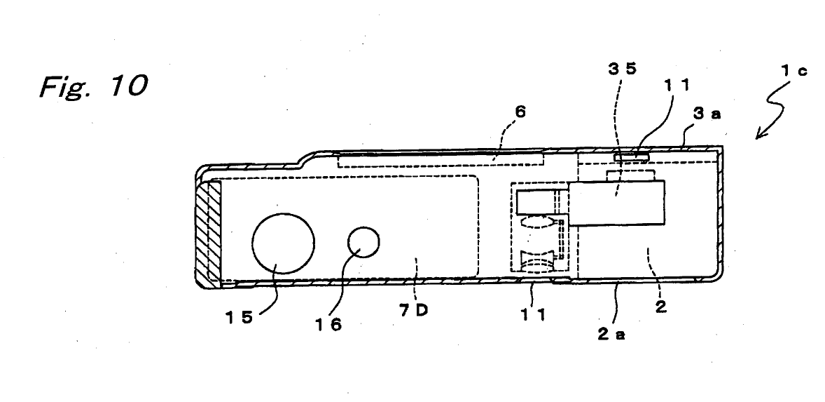

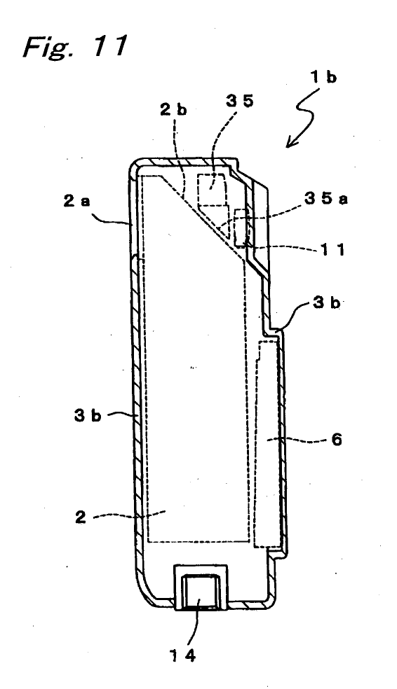

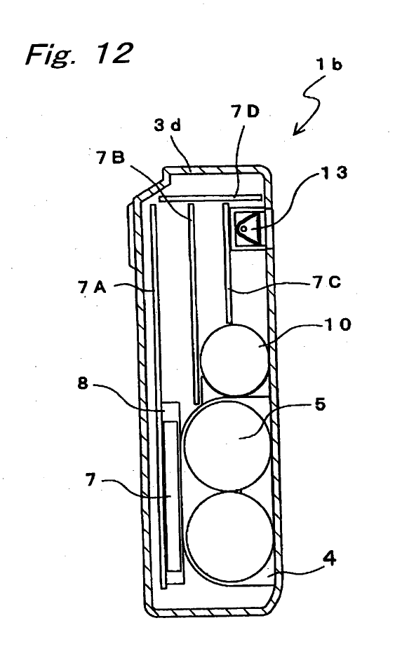

Next, a digital camera according to a third embodiment of the present invention will be described with reference to FIGS. 9 to 12.

A digital camera 1b has a lens barrel unit 2 in a body 3 at the right end viewed from the front wall of the body. The lens barrel unit 2 comprises, like in the above-described embodiments, taking lens units taking in the subject light, a lens barrel, an image sensing device outputting a subject image sensing signal and a zoom driver driving the zoom lens unit. Below the lens barrel unit, a tripod screw 14 is provided.

As shown in the front cross-sectional view of FIG. 9, a liquid crystal display 6 is disposed on the rear wall 3a of the body 3. The liquid crystal display 6 is disposed so as to make a close contact with the rear wall 3a of the body.

At a side of the lens barrel unit 2, a battery cavity 4 for housing batteries 5 and a memory slot 8 for inserting a memory card 9 are provided so as to overlap with each other in the direction of the thickness. The memory slot is fixed onto an A circuit board 7A, and is disposed at a side of the lens barrel unit and behind the battery cavity. The A circuit board 7A is disposed so as to be substantially parallel to the front wall of the camera body.

Above the battery cavity, a flash capacitor 10 is provided so that the direction of the length thereof coincides with the horizontal direction. Behind the flash capacitor 10 and above the battery cavity, a B circuit board 7B is provided. The B circuit board 7B is provided substantially parallel to the A circuit board 7A, and is disposed so as to sandwich the memory slot 8 provided on the A circuit board 7A. The memory card 9 is inserted into the memory slot 8 from below the camera 1c.

Above the flash capacitor 10, a C circuit board 7C to which the flash capacitor 10 is connected is provided so as to be parallel to the A circuit board 7A and the B circuit board 7B. The C circuit board 7C has a notch so as not to interfere with the flash capacitor 10. On the C circuit board 7C, a flash 13 is mounted.

Since the A to C circuit boards 7A to 7C are each small in thickness, even though they are disposed so as to overlap with one another in the direction of the thickness of the body, the overall thickness thereof can be made smaller than the thickness of the lens barrel unit 2.

Above the A to C circuit boards 7A to 7C, a D circuit board 7D is provided so as to be vertical to the circuit boards 7A to 7C and parallel to the top wall 3d of the camera. On the D circuit board 7D, a control device for operation members such as a release button 15 and a main switch 16 is mounted, and the D circuit boards 7D and the buttons such as the release button 15 are connected in the shortest distance and the dead space at the upper end of the body can be effectively used.

At the right side of the D circuit board 7D, a finder 11 is provided. The finder is of a Porro type, and has a finder prism 35 for refracting the subject light from the front surface 3a of the body. The finder prism 35 is structured so as to be capable of directing the incident light to an eyepiece window 11a provided at the upper right end of the rear wall 3a of the body by refracting the light substantially in a hook shape. As shown in FIG. 11, one slanting surface 35a of the finder prism is provided so as to be opposed to a prism slanting surface 2b of the lens barrel unit 2, so that the dead space above the lens barrel unit 2 can be effectively used.

According to the present embodiment, a plurality of circuit boards can be disposed within the range of the camera thickness depending on the lens barrel unit. Consequently, the camera thickness can be reduced while a large circuit board area is secured. Moreover, the circuit boards are disposed so that the portion of connection with the function portion such as the capacitor is shortest, so that the obtained structure is resistant to noise.

As described above, in the digital cameras according to the embodiments, the lens barrel unit having the prism refracting the subject image is disposed on one side at the right end of the body, and in the large space at a side thereof, the circuit boards which are thin members are disposed so as to overlap with one another. Consequently, the thickness can be reduced by determining the thickness of the body with reference to the lens barrel unit and rectangular circuit boards can be disposed, so that facilitation of circuit board formation and reduction in cost can be attained.

Although the present invention has been fully described in connection with the preferred embodiments thereof with reference to the accompanying drawings, it is to be noted that various changes and modifications are apparent to those skilled in the art. Such changes and modifications are to be understood as included with in the scope of the present invention as defined by the appended claims unless they depart therefrom.

What is claimed is:

1. An image forming apparatus, comprising:
a body having a shape being flat in a subject direction when photographing;
a refracting optical system having refracting means for refracting incident light from a subject in a direction vertical to the subject direction;
a power source portion for supplying power to the image forming apparatus; and
a circuit board disposed so as not to overlap with the refracting optical system and the power source portion in a direction of a thickness in the subject direction of the body.

2. An image forming apparatus according to claim 1, wherein the refracting optical system is disposed at an end of the body.

3. An image forming apparatus according to claim 1, wherein the power source portion is disposed at an end of the body.

4. An image forming apparatus according to claim 1, further comprising:
a display portion disposed so as to overlap with the circuit board in the direction of the thickness in the subject direction of the body.

5. An image forming apparatus according to claim 1, further comprising:
a flash capacitor disposed so as to overlap with the circuit board in the direction of the thickness in the subject direction of the body.

6. An image forming apparatus according to claim 1, further comprising:
a recording medium housing portion disposed so as to overlap with the circuit board in the direction of the thickness in the subject direction of the body.

7. An image forming apparatus, comprising:
a body having a shape being flat in a subject direction when photographing;
a refracting optical system disposed at an end of the body, and having refracting means for refracting incident light from a subject in a direction vertical to the subject direction; and
a power source portion for supplying power to the image forming apparatus, and disposed at an another end adjoining the end where the refracting optical system is disposed.

8. An image forming apparatus according to claim 7, further comprising:
a circuit board disposed so as not to overlap with the refracting optical system and the power source portion in the direction of a thickness in the subject direction of the body.

9. An image forming apparatus according to claim 8, further comprising:
a display portion disposed so as to overlap with the circuit board in the direction of the thickness in the subject direction of the body.

10. An image forming apparatus according to claim 8, further comprising:
a flash capacitor disposed so as to overlap with the circuit board in the direction of the thickness in the subject direction of the body.

11. An image forming apparatus according to claim 8, further comprising:
a recording medium housing portion disposed so as to overlap with the circuit board in the direction of the thickness in the subject direction of the body.

12. An image forming apparatus, comprising:
a body having a shape being flat in a subject direction when photographing;
a refracting optical system having refracting means for refracting incident light from a subject in a direction vertical to the subject direction of the body; and
a display portion for displaying a taken image, and disposed so as not to overlap with the refracting optical system in the direction of a thickness in the subject direction of the body and to overlap with the refracting optical system in a direction vertical to the subject direction.

13. An image forming apparatus according to claim 12, wherein the refracting optical system is disposed at an end of the body.

14. An image forming apparatus according to claim 12, further comprising:
a power source portion for supplying power to the image forming apparatus and is disposed so as not to overlap with the refracting optical system and the display portion in the direction of the thickness in the subject direction of the body.

15. An image forming apparatus according to claim 12, further comprising:
a circuit board disposed so as to overlap with the display portion in the direction of the thickness in the subject direction of the body.

16. An image forming apparatus according to claim 15, further comprising:
a second circuit board disposed in the direction of the thickness in the subject direction of the body.

17. An image forming apparatus according to claim 16, further comprising:
a third circuit board disposed in a direction substantially orthogonal to the circuit boards.

18. An image forming apparatus according to claim 12, further comprising:
a recording medium housing portion disposed so as to overlap with the display portion in the direction of the thickness in the subject direction of the body.
